(19) United States
(12) Patent Application Publication
(10) Pub. No.: US 2002/0067043 A1
(43) Pub. Date: Jun. 6, 2002

(54) SYSTEM FOR CONVERSION OF WAVE ENERGY

(76) Inventor: SHMUEL OVADIA, TEL AVIV (IL)

Correspondence Address: THE LAW OFFICE OF EDWARD LANGER, C/O LANDON & STARK ASSOCIATES, 2011 CRYSTAL DRIVE SUITE 210, ARLINGTON,, VA, 22202, US

(21) Appl. No.: 09/431,559

(22) Filed: Oct. 29, 1999

(51) Int. Cl. H02P 9/04

(52) U.S. Cl. 290/53

(57) ABSTRACT

There is thus provided, in accordance with a preferred embodiment of the invention, a system for conversion of wave energy in a body of water having a floor, including:

(a) a stationary support element rigidly mounted to the floor of the body of water;

(b) buoyancy apparatus including a buoy portion having formed therewith wave energy collection apparatus in the form of a cavity integrally formed therewith, the cavity having an opening facing the direction of advancement of oncoming waves;

(c) coupling apparatus for hingedly connecting the buoyancy apparatus to the stationary support element so as to be pivotal in a generally vertical plane with respect to the stationary support element;

(d) at least one piston apparatus for compressing and drawing hydraulic fluid when the piston apparatus is contracted or extended, correspondingly, the piston apparatus being hinged at one end to a stationary support, and hinged at its other end in association with a predetermined element operative to move in response to movement of the buoyancy apparatus;

(e) a hydraulic motor having an energy output; and

(f) a piping system coupling the hydraulic fluid in the piston apparatus to the hydraulic motor.

### FIELD OF THE INVENTION

The present invention relates to the utilization of energy from sea waves and currents and particularly to apparatus for converting sea wave and current energy to consumable energy.

### BACKGROUND OF THE INVENTION

The utilization of the energy produced by the ebb and flow of sea waves has been the subject of numerous and varied proposals. Apparatus has been proposed, both of the floating type and of the type anchored to the sea floor and which convert the wave energy into storable form. Also known are floating buoys or bladders which oscillate vertically, in accordance with forces produced by the waves.

Floating members are particularly suited for the exploitation of gravitational forces induced by the rise and fall of the waves, while static structures are suited more for conversion of a horizontal flow of water, into electricity. It will thus be appreciated that each type of device is suited specifically for exploitation of one of the forms of energy produced by the motion of waves and currents, to the exclusion of the other.

Attempts to convert top electricity generally vertical wave forces, generated by the rise and fall of flotation bladders, have been made using these forces to rotate in order to activate a hydraulic pump. These gears are connected both to the flotation bladders and to a hydraulic pump that discharges fluid into an accumulator when activated, which then delivers fluid so as to operate a suitable type of electrical power plant.

One disadvantage of such apparatus that relies on floating members is that the amount of sea wave energy that may be absorbed thereby is dependent on the location of the member in relation to a tide level that may have a range of up to several meters. Furthermore, some devices include elements that either must be fastened to a stable surface, such as the ocean floor, land, or a suitable platform. This requirements renders such devices expensive to manufacture and/or to maintain, unless they are specifically employed in shallow waters or proximate to the sea shore, thus limiting their utility.

Various solutions have been suggested, including the use of wave transducers connected to computers in order to accurately control the movement of the floating members. These solutions have the disadvantage of requiring sophisticated electronic equipment which is subject to breakdown, may be inefficient, and is costly to install and maintain. Apparatus which is situated away from the shore requires expensive equipment in order to convert the wave energy to an energy form which is easily transferable to the shore.

### SUMMARY OF THE INVENTION

The present invention seeks to provide an efficient and inexpensive system and method of converting energy produced by sea waves into consumable energy, such as electricity, while overcoming disadvantages of known art.

There is thus provided, in accordance with a preferred embodiment of the invention, a system for conversion of wave energy in a body of water having a floor, including:

(a) a stationary support element rigidly mounted to the floor of the body of water;

(b) buoyancy apparatus including a buoy portion having formed therewith wave energy collection apparatus in the form of a cavity integrally formed therewith, the cavity having an opening facing the direction of advancement of oncoming waves;

(c) coupling apparatus for hingedly connecting the buoyancy apparatus to the stationary support element so as to be pivotal in a generally vertical plane with respect to the stationary support element;

(d) at least one piston apparatus for compressing and drawing hydraulic fluid when the piston apparatus is contracted or extended, correspondingly, the piston apparatus being hinged at one end to a stationary support, and hinged at its other end in association with a predetermined element operative to move in response to movement of the buoyancy apparatus;

(e) a hydraulic motor having an energy output; and

(f) a piping system coupling the hydraulic fluid in the piston apparatus to the hydraulic motor.

Additionally in accordance with the present invention, the coupling apparatus include at least two parallel support arms, each of which is hinged to the stationary support element and to the buoyancy apparatus, wherein each support arm is pivotal with respect to the stationary support element and the buoyancy apparatus in a generally vertical plane, wherein corresponding portions of each support arm between its hinges are of equal length , and wherein the buoyancy apparatus is free to move along at least a portion of a circular path described with respect to the stationary support element, in a generally vertical plane, while the buoy portion is retained above the collection apparatus.

Further in accordance with the present invention, the opening is sloped so that its upper edge is closer to oncoming waves than its lower edge.

Additionally in accordance with the present invention, the buoyancy apparatus is formed so as to define a wave diversion surface extending above the opening toward oncoming waves.

In accordance with an alternative embodiment of the invention, there is provided a system for conversion of wave energy in a body of water having a floor, including:

(a) a stationary support element rigidly mounted to the floor of the body of water;

(b) buoyancy apparatus including a buoy portion having formed therewith wave energy collection apparatus in the form of a cavity integrally formed therewith, the cavity having an opening facing the direction of advancement of oncoming waves;

(c) coupling apparatus for hingedly connecting the buoyancy apparatus to the stationary support element wherein the buoyancy apparatus is pivotal in a vertical plane with respect to a predetermined axis in the stationary support element, the coupling apparatus include at least two parallel support arms, each of which is hinged to the stationary element and to the buoyancy apparatus, wherein each support arm is pivotal in a vertical plane about the stationary support element and the buoyancy apparatus, wherein corresponding portions of each support arm between its hinges are of equal length, and wherein the buoyancy apparatus is free to move along at least a portion of a circular path described with respect to the stationary support element, in a generally vertical plane, while the buoy portion is retained above the collection apparatus,

and wherein at least one of the support arms includes a counterbalancing weight extending from the central axis toward the side opposed to the buoyancy apparatus;

(d) at least one piston apparatus for compressing and drawing hydraulic fluid when the piston apparatus is contracted or extended, correspondingly, the piston apparatus being hinged at one end to a stationary support, and hinged at its other end in association with a predetermined element operative to move in response to movement of the buoyancy apparatus;

(e) a hydraulic motor having an energy output; and

(f) a piping system coupling the hydraulic fluid in the piston apparatus to the hydraulic motor.

Additionally in accordance with the present invention, the piping system includes a pressure tank, and the piping system couples the hydraulic fluid in the piston apparatus to the pressure tank, and further couples the pressure tank to the hydraulic motor.

Further in accordance with the present invention, the piping system includes a first conduit for leading hydraulic fluid into the pressure tank when the piston apparatus is contracted, and a second conduit for leading hydraulic fluid into the pressure tank when the piston apparatus is extended.

Additionally in accordance with the present invention, the piping system further includes a hydraulic fluid reserve tank for supplying hydraulic fluid to the piston apparatus, and for collecting hydraulic fluid from the hydraulic motor and, optionally, for collecting excess hydraulic fluid from the pressure tank.

Further in accordance with the present invention, the pressure tank contains a gas maintained at a high pressure for regulating the pressure applied from the pressure tank to the hydraulic motor.

### BRIEF DESCRIPTION OF THE DRAWING

The present invention will be further understood and appreciated from the following detailed description, taken in conjunction with the following enclosed drawing denoted

FIG. 1 which illustrates in a schematic diagram the proposed system for conversion of wave energy to consumable power according to a preferred embodiment of the present invention

### DETAILED DESCRIPTION OF THE INVENTION

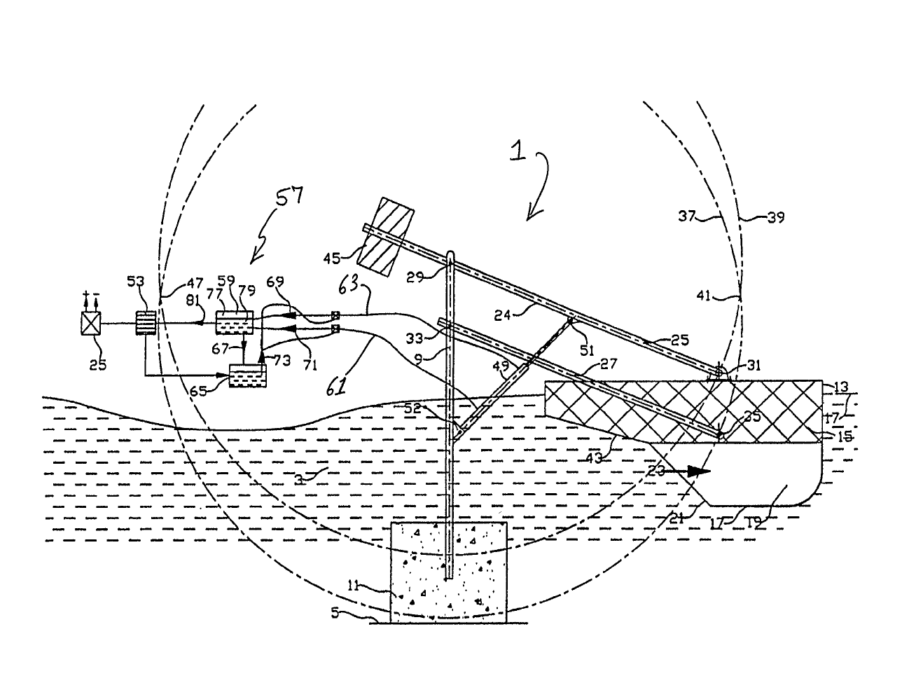

Referring to FIG. 1, there are shown, in schematic form, the main components of the wave energy conversion system, generally denoted 1. System 1 may be installed in substantially any body of water 3 having a floor 5 and a water level 7. Preferably, however, system 1 is employed for the exploitation of large waves that characterize oceans, seas and large lakes.

System 1 includes a stationary support element 9 rigidly mounted to floor 5, such as by means of a concrete mass 11. It will be appreciated that the proportions of all the elements of system 1 in general, and of stationary element 9 in particular are by way of example only, and may vary substantially, in practice. For example, the height and width of stationary support element 9 may be much larger if system 1 is installed in high seas or where the ocean is deep. System 1 is operative to harness wave energy by buoyancy apparatus 13, that is adapted to float on the water. Preferably, buoyancy apparatus 13 is hingedly attached to support element 9 as by suitable coupling apparatus 24, and includes a buoy portion 15, formed with a wave energy collection apparatus 17. Collection apparatus 17 is formed as a cavity 19 having an opening 21 positioned so as to face into the direction of advancement of oncoming waves, indicated by arrow 23.

As described, buoyancy apparatus 13 is hingedly attached to stationary support element 9 by means of a coupling apparatus 24—which is illustrated herein as a plain rod, via which buoyancy apparatus 13 is supported so as to pivot in a generally vertical plane about an axis in stationary element 9.

While coupling apparatus 24 may have a very simple construction, the illustrated construction in FIG. 1 Shows coupling apparatus 24 as having a pair of parallel support arms, referenced 25 and 27, each of which is hinged to stationary support element 9 and to buoyancy apparatus 13. It is clear that more than the illustrated pair of support arms may also be provided. More particularly, support arm 25 is hinged to stationary element 9 at hinge 29 and to buoyancy apparatus 13 at hinge 31; and support arm 27 is hinged to stationary support element 9 at hinge s33 and to buoyancy apparatus 13 at hinge 35. Each support arm is thus pivotal in a vertical plane about its hinges in stationary element 9 and buoyancy apparatus 13. The length of each support arm between its hinges is equal to that of the other, and the respective offsets between hinges 29 and 33, and between hinges 31 and 35, are also equal, thereby resulting in a parallelogram is always defined by the four hinges of each pair of such support arms, such as by axes 29, 31, 33 and 35. It is clear from the above description that if all the support arms, such as arms 25 and 27, were allowed to move freely with respect to respective hinges 29 and 33, each of hinges 31 and 35, having fixed locations with respect to buoyancy apparatus 13, would describes a circular track, 37 and 39, respectively. Thus, buoyancy apparatus 13, too, is free to move along an arc of a circle, whose center is located halfway between axes 29 and 33, in a vertical plane intersecting with stationary support element 9, while buoy portion 15 is maintained above collection apparatus 17. Optionally, the bearing between buoyancy apparatus 13 and the support arms may be constructed so as to limit the movement of the support arms in respect of stationary support element 9, and therefore to limit the buoyancy apparatus 13 to movement along a predetermined arc. Considerations such as structural strength and the ratio between the average wave height and the radius or motion may be taken into account for the specific construction of a system in accordance with the present invention.

It will thus be appreciated that when a wave encounters buoyancy apparatus 13, it floats and rises upwards due to its lighter intrinsic weight. Collection apparatus 19 is either already immersed in the water such that cavity 19 is already filled with water, or cavity 19 fills with water entering through opening 21, at that time. After the wave passes system 1, the water level thereat falls sharply and at this stage the extra weight of the water contained in cavity 19 builds up a significant gravitational force that pulls down buoyancy apparatus 13 with a corresponding, significant force.

It will be appreciated, moreover, that the power of a wave impinging on buoyancy apparatus 13 in a generally horizontal direction, as seen at 23 may be divided into two mutually perpendicular force components; namely, an upward vertical component perpendicular to direction 23, and a horizontal component, in direction 23. In positions between side 41 of the circular path of buoyancy apparatus 13 and the bottom of this path (adjacent to stationary support element 9), both vector forces contribute to the lifting force of buoyancy apparatus 13 toward side 41 while filling cavity 19 with water and adding to the potential gravitational energy accumulated therein. This extra energy is released when the wave passes, as described above. In order to increase the energy absorption of buoyancy apparatus 13, a wall surface 43 thereof, facing the oncoming waves, may be sloped so as to form a wave diversion surface extending above opening 21 toward the oncoming waves, as seen in FIG. 1. Opening 21 may be sloped as well so that its upper edge is closer to the oncoming waves than its lower edge, as in FIG. 1. Such structure of opening 21 also contributes to absorption of more accumulated water in cavity 19 when a wave hits buoyancy apparatus 13 and to release of more water after the wave has passed.

Optionally, at least one of the support arms, such as arm 25 in FIG. 1, may includes a counterbalancing weight 45 extending outwardly with respect to central axis 29, toward the side opposed to buoyancy apparatus 23.

It will be appreciated that since buoyancy apparatus 13 moves along a circular path that the rise and fall of the waves contribute more to the vertical force component, in the vicinity of lateral regions 41 and 47 of the circular path, rather than the top or bottom thereof Accordingly, system 1 may be constructed so as to position buoyancy apparatus 13 most of the time in the vicinity of sides 41 or 47 of its circular path in a body of water having a large amount of wave activity. In a body of water in which changing undercurrents are relatively dominant, however, system 1 may be constructed such that buoyancy apparatus 13 is positioned, for the most part, closer to the top of bottom of its circular path.

In addition, in cases where waves tend to change their oncoming direction relative to direction 23, system 1 may be easily adapted to change its orientation so as to face the right direction of the oncoming waves. This may be accomplished, for instance, by rendering stationary support element 9, or at least an upper portion thereof, freely movable about an axis therealong, with a “pointed” hydrodynamic shaping of buoyancy apparatus 13, and optionally, weight 45, so as to function in a manner similar to weather vanes.

In order to convert the wave energy in to consumable energy, system 1 preferably includes at least one hydraulic-type system, such as piston apparatus 49, for compressing and drawing hydraulic fluid when the piston apparatus is contracted or extended, correspondingly. Piston apparatus 49 is hinged attached at one end—such as at hinge 51, to one of the support arms, for example,—arm 25, distally from hinge 29, or, alternatively, directly to buoyancy apparatus 13. Piston apparatus 49 is hingedly connected via a hinge 52 at its other end, to a stationary support, namely, stationary support element 9, or floor 5.

System 1 further includes an hydraulic motor 53 mechanically coupled to an electric generator or to any other suitable device. Finally, system 1 includes a piping system 57 coupling hydraulic fluid in piston apparatus 49 to hydraulic motor 53.

As an optional feature, piping system 57 may include a pressure tank 59. In such a case piping system 57 couples the hydraulic fluid in piston apparatus 49 to pressure tank 59, and further couples pressure tank 59 to hydraulic motor 53.

In accordance with a preferred embodiment of the invention, piping system 57 includes conduits 61 and 63 for conveying hydraulic fluid between piston apparatus 49 and pressure tank 59. First conduit 61 is employed for conveying hydraulic fluid into pressure tank 59 when piston apparatus 49 is contracted, and second conduit 63 is employed for conveying hydraulic fluid into pressure tank 59 when piston apparatus 49 is extended.

Piping system 57 may constitute a simple closed circuit that directly connects piston apparatus 49 with to hydraulic motor 53. Preferably, however, piping system 57 also includes an hydraulic fluid reserve tank 65 for supplying hydraulic fluid to piston apparatus 49, and for collection hydraulic fluid from hydraulic motor 53. In the above-described embodiment in which pressure tank 59 also forms part of piping system 57, hydraulic fluid reserve tank 65 serves to supply hydraulic fluid to piston apparatus 49, and to collect hydraulic fluid from hydraulic motor 53 and excess hydraulic fluid from pressure tank 59.

Preferably, piping system 57 further includes a plurality of one-way pressure relief or pressure difference control valves for confining the flow of hydraulic fluid to the desired directions. For example, hydraulic fluid pressure tank 59 may be fitted with pressure relief valves 67 for draining excess fluid from tank 59. One possible arrangement of one way valves is shown in FIG. 1. Valves 69 and 71 are mounted on conduits 61 and 63, respectively, and allow one-way flow only toward pressure tank 59, or to hydraulic motor 53, if directly fed by conduits 61 and 63). Valve 73 allows one way flow only from hydraulic fluid reserve tank 65—toward conduits 61 and 63—in the presence of a negative pressure gradient thereat in either of these conduits. Equivalent arrangements, including such that include valves that are mechanically or electronically coupled or controlled may be employed for similar purposes.

It will be appreciated by persons skilled in the art that pressure tank 59 is an intermediate device used for regulating abrupt pressure changes produced by piston apparatus 49 in response to abrupt motions of buoyant apparatus 13 in high seas. Pressure tank 59 preferably contains a gas 77 maintained under high pressure, such as hundreds of Atmospheres, and a reservoir 79 of hydraulic fluid. The pressure in pressure tank 59 builds up as piston apparatus 49 feeds more and more hydraulic fluid into pressure tank 59. The presence of the pressurized gas, which is preferably inert, regulates the pressure conveyed from pressure tank 59 to hydraulic motor 53. If hydraulic oil is used as the hydraulic fluid, Nitrogen may be used as a substantially inexpensive gas which is inactive with the hydraulic fluid. A valve 81 allows one way flow of hydraulic fluid from pressure tank 59 to hydraulic motor 53—when the pressure in pressure tank 59 builds up to reach a predetermined level or when valve 81 is opened by an external control.

It will be appreciated by those skilled in the art that the invention is not limited to what has been shown and described hereinabove by way of example only. Rather, the invention is limited solely by the claims which follow.

1. A system for conversion of wave energy in a body of water having a floor, including:
(a) a stationary support element rigidly mounted to the floor of the body of water;
(b) buoyancy apparatus including a buoy portion having formed therewith wave energy collection apparatus in the form of a cavity integrally formed therewith, the cavity having an opening facing the direction of advancement of oncoming waves;
(c) coupling apparatus for hingedly connecting said buoyancy apparatus to said stationary support element so as to be pivotal in a generally vertical plane with respect to said stationary support element;
(d) at least one piston apparatus for compressing and drawing hydraulic fluid when said piston apparatus is contracted or extended, correspondingly, said piston apparatus being hinged at one end to a stationary support, and hinged at its other end in association with a predetermined element operative to move in response to movement of said buoyancy apparatus;
(e) a hydraulic motor having an energy output; and
(f) a piping system coupling said hydraulic fluid in said piston apparatus to said hydraulic motor.

2. The system as claimed in claim 1, wherein said coupling apparatus include at least two parallel support arms, each of which is hinged to said stationary support element and to said buoyancy apparatus, wherein each support arm is pivotal with respect to said stationary support element and said buoyancy apparatus in a generally vertical plane, wherein corresponding portions of each support arm between its hinges are of equal length, and wherein said buoyancy apparatus is free to move along at least a portion of a circular path described with respect to said stationary support element, in a generally vertical plane, while said buoy portion is retained above said collection apparatus.

3. The system as claimed in claim 1, wherein said opening is sloped so that its upper edge is closer to oncoming waves than its lower edge.

4. The system as claimed in claim 1, wherein said buoyancy apparatus is formed so as to define a wave diversion surface extending above said opening toward oncoming waves.

5. A system for conversion of wave energy in a body of water having a floor, including:
(a) a stationary support element rigidly mounted to the floor of the body of water;
(b) buoyancy apparatus including a buoy portion having formed therewith wave energy collection apparatus in the form of a cavity integrally formed therewith, the cavity having an opening facing the direction of advancement of oncoming waves;
(c) coupling apparatus for hingedly connecting said buoyancy apparatus to said stationary support element wherein said buoyancy apparatus is pivotal in a vertical plane with respect to a predetermined axis in said stationary support element, said coupling apparatus include at least two parallel support arms, each of which is hinged to said stationary element and to said buoyancy apparatus, wherein each support arm is pivotal in a vertical plane about said stationary support element and said buoyancy apparatus, wherein corresponding portions of each support arm between its hinges are of equal length, and wherein said buoyancy apparatus is free to move along at least a portion of a circular path described with respect to said stationary support element, in a generally vertical plane, while said buoy portion is retained above said collection apparatus,
and wherein at least one of said support arms includes a counterbalancing weight extending from said central axis toward the side opposed to said buoyancy apparatus;
(d) at least one piston apparatus for compressing and drawing hydraulic fluid when said piston apparatus is contracted or extended, correspondingly, said piston apparatus being hinged at one end to a stationary support, and hinged at its other end in association with a predetermined element operative to move in response to movement of said buoyancy apparatus;
(e) a hydraulic motor having an energy output; and
(f) a piping system coupling said hydraulic fluid in said piston apparatus to said hydraulic motor.

6. The system as claimed in claim 1, wherein said piping system includes a pressure tank, and said piping system couples said hydraulic fluid in said piston apparatus to said pressure tank, and further couples said pressure tank to said hydraulic motor.

7. The system as claimed in claim 1, wherein said piping system includes a first conduit for leading hydraulic fluid into said pressure tank when said piston apparatus is contracted, and a second conduit for leading hydraulic fluid into said pressure tank when said piston apparatus is extended.

8. The system as claimed in claim 1, wherein said piping system further includes a hydraulic fluid reserve tank for supplying hydraulic fluid to said piston apparatus, and for collecting hydraulic fluid from said hydraulic motor.

9. The system as claimed in claim 6, wherein said piping system further includes a hydraulic fluid reserve tank for supplying hydraulic fluid to said piston apparatus, and for collecting hydraulic fluid from said hydraulic motor and excess hydraulic fluid from said pressure tank.

10. The system as claimed in claim 6, wherein said piping system further includes a plurality of one-way valves.

11. The system as claimed in claim 6, wherein at least one of said pressure tank and said hydraulic motor are fitted with pressure relief valves for draining excess fluid therefrom.

12. The system as claimed in claim 6, wherein said pressure tank contains a gas maintained at a high pressure for regulating the pressure applied from said pressure tank to said hydraulic motor.
